(19) United States
(12) Patent Application Publication
(10) Pub. No.: US 2024/0180144 A1
(43) Pub. Date: Jun. 6, 2024

(54) BAIT STATION FOR RODENT TRAP

(71) Applicant: David Schuelke, Park City, UT (US)

(72) Inventor: David Schuelke, Park City, UT (US)

(21) Appl. No.: 18/468,634

(22) Filed: Sep. 15, 2023

Related U.S. Application Data
(60) Provisional application No. 63/429,453, filed on Dec. 1, 2022.

(51) Int. Cl. A01M 23/30

(52) U.S. Cl. CPC A01M 23/30

(57) ABSTRACT

A bait station for a rodent trap, the bait station adapted to prevent flipping of the rodent trap when activated, the bait station comprises an elongated protuberance affixed to a top surface of a base place, the elongated protuberance comprising a mounting camera oriented to film the rodent trap and begin filming when a proximity sensor is activated in some embodiments.

### FIELD OF THE INVENTION

This invention relates to rodent traps and more particularly relates to rodent traps adapted primarily for catching rats and mice.

### BACKGROUND

### Description of the Related Art

Many apparati are known in the art for trapping rodents such as mice and rats, which present a danger to homes in the form of diseases. Commercial businesses are commonly closed as a result of rodent infestation as rodents' gnawing, urine and feces can poison humans or infect humans with any of a plurality of deadly viruses, including hantavirus.

Rodents typically invade through cracks, spaces and openings (such as vents, pipes and chimney access points) into a home. Traditional snap traps are often used by homeowners and pest control specialists to attempt to rid homes of rodent infestations, but these traps usually placed only where easily accessible by homeowners. Problematic in the art is that rodents typically occupy places in buildings which are not easily accessible by pest control specialists or homeowners, such as above ceilings or within walls.

Wooden snap traps are common, but expose the homeowner, for example, to the undesirable task of disposing of the dead mouse once trapped. In addition, once trapped, the exposed dead mouse can pose health problems or cause distress to, for example, children. Such traps are also pose a danger to pets who may inadvertently activate the trigger and injure themselves. Whilst mousetraps have been developed which do not kill the rodent, they also cannot be optimally placed.

Attempting to rid a building of rodents can be an expensive, labor intensive and time-consuming exercise and is not always possible. Other traditional methods of dealing with rodent invasions involves the use of poisoned baits (rodenticides) that contain anticoagulants, such as warfarin, pival and chlorophacinone. Such baits are nevertheless toxic and are therefore undesirable for use in the home, particularly those in which children and pets reside and which may be inadvertently exposed to these poisons. In addition, poisoned mice often die in inaccessible locations thereby resulting in an unpleasant odor upon death of the mouse.

Traditional snap traps suffer from a variety of inefficiencies, including that they tend to flip over when activated because the base plates are not wide enough. With emerging technologies, it is desirable for a homeowner or business owner to mount cameras near snap traps to see when a rodent is caught or when rodents escape. Traditionally snap traps provide no such means.

Such traps are desirably simple and cost effective to manufacture and are also able to efficiently trap mice. Traditional trapping devices do not provide a means for performing these functions and device which is operable to do so is desirable.

### SUMMARY

From the foregoing discussion, it should be apparent that a need exists for a live rodent trap with vacuum function. Accordingly, the present invention has been developed to provide a bait station adapted to secure a rodent trap in place, the bait stations comprising: a planar base plate defining a bore dimensioned in congruency with a dimension of an outer surface of the sidewall; an elongated protuberance jutting superiorly from a top surface of the base plate, the elongated protuberance affixed at a proximal end to the base plate and affixed at a distal end to a proximity sensor; the proximity sensor affixed to the distal end, the proximity sensor adapted to activate a digital camera in response to detection of motion; a digital camera oriented such that a snap trap is in a field of view of the sensor; a switch operable to power on the digital camera.

The bait station may further comprise one or more of a wireless transceiver, a camera, a microphone, and motion detector. The bait station may define a bore hole traversing the base plate longitudinally. In some embodiments, the bait station further comprises a snap trap adhered to a top surface of the base plate. The elongated protuberance may be between 2 and 20 inches in length. In some embodiments, the base plate is 60-200% wider than the snap trap such that the snap trap does not flip over when activated.

A second bait station adapted to secure a rodent trap in place is provided, the bait stations comprising: a planar base plate defining a bore dimensioned in congruency with a dimension of an outer surface of the sidewall; an adhesive affixed to a top surface of the base plate for adhering the rodent trap to the base plate; an elongated protuberance jutting superiorly from a top surface of the base plate, the elongated protuberance affixed at a proximal end to the base plate and affixed at a distal end to a proximity sensor, the elongated protuberance positioned within one inch of an edge of the planar base plate; the proximity sensor affixed to the distal end, the proximity sensor adapted to activate a digital camera in response to detection of motion; a digital camera oriented such that a snap trap is in a field of view of the sensor; a switch operable to power on the digital camera.

The elongated protuberance may taper.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an environmental, side perspective view illustrating one embodiment of a bait station for a rodent trap in accordance with the present invention; and

FIG. 2 is a side perspective view illustrating one embodiment of a bait station for a rodent trap in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide a bait station for a rodent trap which does not flip over and incorporates camera or motion-activated function.

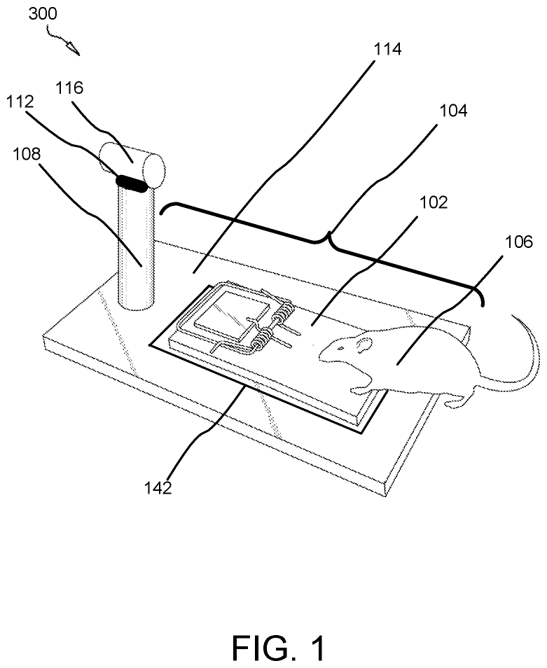

FIG. 1 is an environmental, side perspective view illustrating one embodiment of a bait station 100 for a rodent trap in accordance with the present invention.

In various embodiments, the bait station 100 comprises a base plate 104, which may comprise a board fabricated from organic materials such as wood, polymeric materials, or metal alloys. The bait station 100 comprises a planar bottom surface and may comprise a planar top surface. The base plate 104 may be rectangular, square or ovoid in shape, and between 0.1 and 1 inches thick. In various embodiments, the base plate 104 comprises a sticky top surface, or adhesive, adapted to adhere a top surface of the base plate to a trap 102. The adhesive may comprise double-sided tape 142.

In various embodiments, a snap trap 102 adapted to catch rodents affixes to a top surface 114 of the bait station. The snap trap 102 may affix using means known to those of skill in the art, including glues/adhesives, screws, nails, snap fits, and the like.

The bait station 100 and the base plate 104 are wider and longer than the snap trap 102. In various embodiments, the bait station 100 is 60-300% wider than the snap trap 102.

The base plate 104 may be rectangular, square, ovoid or otherwise shaped. In some embodiments, a protuberance 108, or handle, affixes to a top surface 114 of the base plate 104. The protuberance 108 may comprise a shaft, rod, stick or other protuberance jutting superiorly from the top surface 114. The protuberance 108 may threaded and screw into an aperture on the base plate 104. In various embodiments, the protuberance 108 is spaced between 0.2 and 2 inches from a distal edge of the base plate 104. In other embodiments, the protuberance 108 is spaced 0.2 to 2 inches from three separate edge of the base plate 104.

In some embodiments, the protuberance 108 is arcuate to position a camera in an angled position above the trap 102. The protuberance 108 may be flexible, or semi-rigid, to allow the protuberance 108 to be bent or angled manually to adjust the camera position. The protuberance 108 may taper as it rises superiorly.

In various embodiments, the protuberance 108 is 2 to 20 inches tall. Higher than this, the protuberance 108 may cause a bait station of standard dimensions to become top heavy and flip.

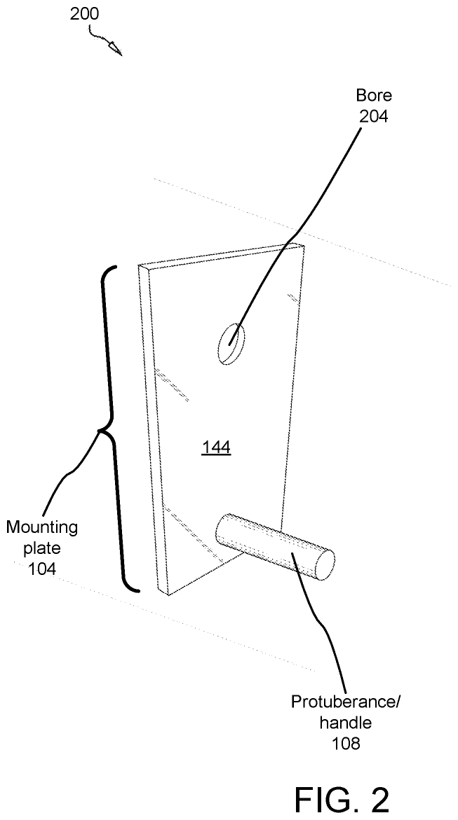

FIG. 2 is a side perspective view illustrating one embodiment of a bait station for a rodent trap in accordance with the present invention.

The base plate 104 defines a bore 304, or aperture, which traverses the base plate 310. The bore 304 is dimensioned to receive the distal end 120 of the tubular component 120. The bore 304 may be two inches in diameter, or may be 1 to six inches in diameter.

In various embodiments, the mounting/base plate 106 may detachably affixes to a wall surface, a ceiling, a column, or another interior or exterior surface of a building. The bore 204 may dispose over a corresponding bore drilled into the surface upon which the mounting plate 104 is positioned.

The bait station 110 may comprise a sensor 112, which may be a proximity sensor. In various other embodiments, the sensor 112 may comprise a light-sensor for detecting changes in light in the ambient area. The sensor 112 may be operable to switch on a digital camera 116 for recording and transmitting an image or video stream to the external data-processing device (DPD). The light sensor may comprise any sensor of light or electromagnetic energy known to those of skill in the art, including a photoemission sensor, a photoelectric sensor, a photovoltaic sensor, a thermal sensor, a polarization sensor, a photochemical sensor and the like, or any combination of the above. Activation of the sensor 112 switches on the camera 116.

The camera 114 may be mounted above the protuberance 108 on a distal end of the protuberance 108. The proximal end of the protuberance 108 is affixed to the top surface 114.

The rodent 106 is attracted to the snap trap 102 by bait placed within the snap trap 102. The bait may include baits known to be used in rodent traps by those of skill in the art, including cheese, chocolate, and perishable foods.

When the rodent 106 approaches the trap 102, the rodent 106 activates the sensor 112 and the camera 114 in response, which camera 114 begins filming.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bait station adapted to secure a rodent trap in place, the bait stations comprising:
a planar base plate defining a bore dimensioned in congruency with a dimension of an outer surface of the sidewall;
an elongated protuberance jutting superiorly from a top surface of the base plate, the elongated protuberance affixed at a proximal end to the base plate and affixed at a distal end to a proximity sensor, the elongated protuberance positioned within one inch of an edge of the planar base plate;
the proximity sensor affixed to the distal end, the proximity sensor adapted to activate a digital camera in response to detection of motion;
a digital camera oriented such that a snap trap is in a field of view of the sensor;
a switch operable to power on the digital camera.

2. The bait station of claim 1, further comprising one or more of a wireless transceiver, a camera, a microphone, and motion detector.

3. The bait station of claim 1, defining a bore hole traversing the base plate longitudinally.

4. The bait station of claim 1, further comprising a snap trap adhered to a top surface of the base plate.

5. The bait station of claim 1, wherein the elongated protuberance is between 2 and 20 inches in length.

6. The bait station of claim 1, wherein the base plate is 60-200% wider than the snap trap such that the snap trap does not flip over when activated.

7. A bait station adapted to secure a rodent trap in place, the bait stations comprising:
a planar base plate defining a bore dimensioned in congruency with a dimension of an outer surface of the sidewall;
an adhesive affixed to a top surface of the base plate for adhering the rodent trap to the base plate;
an elongated protuberance jutting superiorly from a top surface of the base plate, the elongated protuberance affixed at a proximal end to the base plate and affixed at a distal end to a proximity sensor, the elongated protuberance positioned within one inch of an edge of the planar base plate;
the proximity sensor affixed to the distal end, the proximity sensor adapted to activate a digital camera in response to detection of motion;
a digital camera oriented such that a snap trap is in a field of view of the sensor;
a switch operable to power on the digital camera.

8. The bait station of claim 9, wherein the elongated protuberance tapers.
